(19) United States
(12) Patent Application Publication
(10) Pub. No.: US 2026/0047545 A1
(43) Pub. Date: Feb. 19, 2026

(54) Absorbent Pad for Animal Waste Displaying a Fluorescent Attractant

(71) Applicant: Boxiecat LLC, Santa Monica, CA (US)

(72) Inventors: Josh Wiesenfeld, Santa Monica, CA (US); Linda Ko, Colorado Springs, CO (US)

(73) Assignee: Boxiecat LLC, Santa Monica, CA (US)

(21) Appl. No.: 19/370,625

(22) Filed: Oct. 27, 2025

Related U.S. Application Data
(63) Continuation-in-part of application No. 18/605,187, filed on Mar. 14, 2024, now Pat. No. 12,484,546.
(60) Provisional application No. 63/452,132, filed on Mar. 14, 2023.

(51) Int. Cl. A01K 1/015

(52) U.S. Cl. CPC A01K 1/01577

(57) ABSTRACT

An animal attractive absorbent pad comprising an absorbent pad that displays at least one fluorescent compound; wherein the at least one fluorescent compound fluorescent compound fluoresces in the absence of urine, feces, blood, and other bodily fluids; wherein the at least one fluorescent compound is detectable on the absorbent pad when the absorbent pad is exposed to ultraviolet light; and wherein the at least one fluorescent compound attracts animals such as cats and dogs to eliminate on the absorbent pad.

### CROSS-REFERENCE TO RELATED APPLICATIONS

This application is a Continuation-in-Part of U.S. Utility Patent Application Ser. No. 18/605,187 filed Mar. 14, 2024, which is hereby incorporated by reference, and the claims the benefit of Provisional Patent Application 63/452,132 filed Mar. 14, 2023, which is hereby incorporated by reference.

### STATEMENT REGARDING FEDERALLY SPONSORED RESEARCH

Not Applicable.

### APPENDIX

Not Applicable.

### BACKGROUND OF THE INVENTION

### Field of the Invention

The present disclosure relates generally to absorbent pads for animal defecation and/or urination that display fluorescent compounds to attract animals to the absorbent pad.

### Related Art

Absorbent pads are often used in the litter box or around the litter box for the cat's elimination of urine and fecal matter. They are also used in pet kennels or around a house for urination by dogs or puppies. A typical absorbent pad is approximately flat, rectangular, and from 1 to 4 feet wide by about 1 to 4 feet long. The pad is from about 0.1 inch to 4 inches thick, preferably from 0.1 to 1 inch thick.

Attractants are added to litter and used to attract cats to the litter for elimination purposes. These include pheromones, black currant oil, black seed oil, catnip, cat grass, chamomile, lavender, licorice, Matatabi, methalactone, 3-Mercapto-3-methylbutan-l-ol, musk oil, peppermint oil, pine oil, rosemary, vanillin, and white truffle oil. However, these attractants have limited success. Attractants are also used with absorbent pads to attract cats.

Attractants are also added to absorbent pads to attract cats and dogs. Japanese patent JP 3114208 discloses absorbent pads for cats and dogs, wherein the pad had phosphorescent materials along its periphery. Phosphorescent pigments are more commonly known as glow-in-the-dark pigments. These pigments have the ability to absorb energy from the light source and store it for a short period of time. After removing the light source, the object starts to glow. The object is now giving up the stored energy in the form of light. These pigments need to be charged before they can emit any color in the dark. The charged pigments can glow for anywhere from seconds to hours depending on the strength. The phosphorescent material glows green and can be easily found by the cat or dog in the dark. The present invention does not use phosphorescent materials.

Chinese patent CN221948960 discloses the use of essential oils on the absorbent pad to relieve stress for the animal using the pad.

Patent application WO2016/170475 relates to the use of L-Felinine, a cat pheromone precursor, to attract a cat to eliminate in a litter, which is hereby incorporated by reference. U.S. Patent publication US2021/0087161 discloses methods and uses of a composition comprising 2,2-dimethyl-1,3-dioxolane-4-methanol in pet litters, in particular for promoting in-litter elimination by pets, which is hereby incorporated by reference. The present invention does not use L-Felinine pheromone.

It has been reported that dogs have the ability to see ultraviolet light and that cats have the ability to see blues and ultraviolet (UV) light. Cats do not perceive red colors. Since many fluorescent compounds emit blue and UV light, it is likely that dogs and cats are attracted to fluorescent compounds. Fluorescent colors can absorb light waves such as ultraviolet UV rays and re-emit them, which causes the object to look as if it's glowing even in daylight. This is why fluorescent colors are commonly used for safety applications. These compounds, when used on an attractive cat absorbent pads could be used to attract the cat to eliminate on the absorbent pad.

None of the above-listed references disclose the use of an ultraviolet attractant with an absorbent pad for cats.

### SUMMARY OF THE INVENTION

The present invention is an animal attractive absorbent pad which comprises an absorbent pad displaying at least one fluorescent compound, wherein the at least one fluorescent compound is detectable on the absorbent pad by glowing when the absorbent pad is exposed to ultraviolet light, wherein the at least one fluorescent compound attracts animals such as dogs and cats to use the absorbent pad. The absorbent pad can be disposable, reusable, or washable.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION OF THE PREFERRED EMBODIMENTS

The following description of the preferred embodiment(s) is merely exemplary in nature and is in no way intended to limit the invention, its application, or uses.

The animal attractive absorbent pad comprises an absorbent pad displaying at least one fluorescent compound. The absorbent pad can be of any well-known shape or size. Typically, the absorbent pad has a water-permeable polymer top layer, an absorbent middle layer, and a water-impermeable bottom layer. The middle layer may be a super absorbent polymer. Washable absorbent pads may have an absorbent top layer and a water-impermeable bottom layer. The top layer may be a microfiber fabric that absorbs and holds liquids.

Displayed on the absorbent pad is at least one fluorescent compound. The fluorescent compound must not be harmful to animals or the environment. Fluorescent whitening agents, called optical brighteners, are fluorescent materials that can absorb UV light and emit visible (blue-violet). When exposed to white light, they can also emit some UV light. Preferably, they are hydrophilic water-soluble compounds, and are mainly anionic diamino stilbene (DAS) or distyryl biphenyl (DSBP) derivatives displaying a low aquatic toxicity. The most common classes of compounds with this property are the stilbenes, e.g., 4,4′-diamino-2,2′-stilbenedisulfonic acid. The compounds 4,4′-bis(benzoxazolyl)-cis-stilbene and 2,2′-(2,5-thiophenediyl)-bis(5-tert-butylbenzoxazole) are also intensely fluorescent and used as optical brighteners. A commercially available dry optical brightener powder is KEYFLUOR™ WHITE OB sold by Millikin. The fluorescent compound present in the optical brightener is 2,2′-(2,5-thiophenediyl)-bis(5-tert-butylbenzoxazole), cas #7128-64-5, and is not water soluble. A water soluble optical brightener is Pylaklor White S-15A, Pylaklor White S-15A made by Pylam Dyes, and contains 4-(2H-Naphtho[1,2-d]triazol-2-yl)-2-stilbenesulfonic acid sodium salt.

Typically the coating or the polymer top layer contains from about 0.01 to about 10.0 wt. % fluorescent material. More preferably, the amount of fluorescent material is from about 0.05 to 5.0 wt. % on the coating or the polymer. The amount of fluorescent material needed must be sufficient that, when ultra violet light is shown on the absorbent pad, the fluorescent material visibly glows.

The at least one fluorescent compounds of the present invention are not limited to optical brighteners. However, it is well know that animal urine is a fluorescent material, and animal urine is not included in the fluorescent compounds of the present invention. Additionally, the compounds contemplated in this invention fluoresce in the absence of urine, blood, feces or other bodily fluids that are known to activate fluorescence in compounds such as luminol.

In a preferred embodiment, the fluorescent compound is applied to the absorbent pad as a coating, or a partial coating applied in a decorative manner. Fluorescent paints can be applied to the absorbent pad. In a preferred embodiment, the fluorescent compound is blended with a translucent or transparent paint and applied to the surface of the absorbent pad. In another embodiment, the fluorescent compound is applied as an applique, or as an adhesive-backed laminate.

In another embodiment, the fluorescent compound is blended into a polymer before the polymer forms the top, bottom or side of the absorbent pad. In a preferred embodiment, the polymer is a translucent or a transparent polymer.

### Examples of the Invention—An Animal Attractant Absorbent Pad

Example 1—An absorbent pad has paint applied to its perimeter. The paint is a fluorescent paint with a transparent base and contains a 5% UV fluorescent compound. The fluorescent compound is a dry optical brightener powder is KEYFLUOR™ WHITE OB sold by Millikin. The fluorescent compound present in the optical brightener is 2,2′-(2,5-thiophenediyl)-bis(5-tert-butylbenzoxazole), cas #7128-64-5 and is not water soluble. When ultra violet light is shown on the absorbent pad, it visibly glows a blue-white color.

Example 2—An absorbent pad is painted around its perimeter with fluorescent paint. The fluorescent paint has a transparent base and contains a 5% UV fluorescent compound. The fluorescent compound is a water soluble optical brightener is Pylaklor White S-15A, Pylaklor White S-15A is made by Pylam Dyes, and contains 4-(2H-Naphtho[1,2-d]triazol-2-yl)-2-stilbenesulfonic acid sodium salt. When ultra violet light is shown on the absorbent pad, the perimeter visibly glows a blue-white color.

Example 3—Fluorescent adhesive tape is applied to the perimeter of an absorbent pad. ViVViD DECO65 glow in the dark permanent adhesive craft vinyl tape is used. When ultra violet light is shown on the absorbent pad, the perimeter visibly glows a blue color.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. An animal attractant absorbent pad comprising an absorbent pad and at least one fluorescent compound,
wherein the absorbent pad does not contain urine;
wherein the at least one fluorescent compound fluoresces in the absence of urine, feces, blood, and other bodily fluids;
wherein the at least one fluorescent compound visibly glows when the absorbent pad is exposed to ultraviolet light; and
wherein the at least one fluorescent compound attracts the animal to eliminate on the absorbent pad.

2. The animal attractant absorbent pad of claim 1,
wherein the at least one fluorescent compound fluoresces in the UV, violet and blue spectra.

3. The animal attractant absorbent pad of claim 1, wherein the at least one fluorescent compound comprises anionic diamino stilbene or distyryl biphenyl derivatives.

4. The animal attractant absorbent pad of claim 3, wherein the at least one fluorescent compound comprises 4,4′-diamino-2,2′-stilbenedisulfonic acid.

5. The animal attractant absorbent pad of claim 3, wherein the at least one fluorescent compound comprises 4,4′-bis(benzoxazolyl)-cis-stilbene or 2,2′-(2,5-thiophenediyl)-bis(5-tert-butylbenzoxazole).

6. The animal attractant absorbent pad of claim 2, wherein the at least one fluorescent compound comprises 4-(2H-Naphtho[1,2-d]triazol-2-yl)-2-stilbenesulfonic acid sodium salt.

7. The animal attractant absorbent pad of claim 2,
wherein the absorbent pad has a polymer top layer; and
wherein the at least one fluorescent compound is applied as a coating, applique, adhesive-backed laminate on the polymer top layer of the absorbent pad.

8. The animal attractant absorbent pad of claim 7, wherein the polymer top layer is translucent or transparent and the at least one fluorescent compound is embedded in the polymer top layer.

9. The animal attractant absorbent pad of claim 8, wherein the polymer top layer has a translucent or transparent coating containing at least one fluorescent compound.

10. A washable animal attractant absorbent pad comprising an absorbent pad and at least one fluorescent compound,
wherein the absorbent pad does not contain urine;
wherein the at least one fluorescent compound fluoresces in the absence of urine, feces, blood, and other bodily fluids;
wherein the at least one fluorescent compound visibly glows when the absorbent pad is exposed to ultraviolet light; and
wherein the at least one fluorescent compound attracts the animal to eliminate on the absorbent pad.

11. The washable animal attractant absorbent pad of claim 10, wherein the pad has a top layer and a bottom layer, wherein the top layer is an absorbent fabric and the bottom layer is water-impermeable.

12. The washable animal attractant absorbent pad of claim 10, wherein the at least one fluorescent compound fluoresces in the UV, violet and blue spectra.

13. The washable animal attractant absorbent pad of claim 11, wherein the at least one fluorescent compound comprises anionic diamino stilbene or distyryl biphenyl derivatives.

14. The washable animal attractant absorbent pad of claim 10, wherein the at least one fluorescent compound comprises 4,4′-diamino-2,2′-stilbenedisulfonic acid.

15. The washable animal attractant absorbent pad of claim 10, wherein the at least one fluorescent compound comprises 4,4′-bis(benzoxazolyl)-cis-stilbene or 2,2′-(2,5-thiophenediyl)-bis(5-tert-butylbenzoxazole).

16. The washable animal attractant absorbent pad of claim 10, wherein the at least one fluorescent compound comprises 4-(2H-Naphtho[1,2-d]triazol-2-yl)-2-stilbenesulfonic acid sodium salt.

17. An animal attractant absorbent pad comprising an absorbent pad and at least one fluorescent compound,
wherein the absorbent pad has a water-permeable top layer, an absorbent middle layer, and a water-impermeable bottom layer;
wherein the absorbent pad does not contain urine;
wherein the at least one fluorescent compound fluoresces in the absence of urine, feces, blood, and other bodily fluids;
wherein the at least one fluorescent compound visibly glows when the absorbent pad is exposed to ultraviolet light; and
wherein the at least one fluorescent compound attracts the animal to eliminate on the absorbent pad.

18. The animal attractant absorbent pad of claim 17,
wherein the at least one fluorescent compound fluoresces in the UV, violet and blue spectra.

19. The animal attractant absorbent pad of claim 17, wherein the polymer top layer has a translucent or transparent coating containing at least one fluorescent compound.

20. The animal attractant absorbent pad of claim 17, wherein the at least one fluorescent compound is selected from the group consisting of 4,4′-diamino-2,2′-stilbenedisulfonic acid, 4,4′-bis(benzoxazolyl)-cis-stilbene, 2,2′-(2,5-thiophenediyl)-bis(5-tert-butylbenzoxazole), and 4-(2H-Naphtho[1,2-d]triazol-2-yl)-2-stilbenesulfonic acid sodium salt.
